(19) United States
(12) Patent Application Publication
(10) Pub. No.: US 2004/0149798 A1
(43) Pub. Date: Aug. 5, 2004

(54) Crafting dispenser and dispenser system

(75) Inventors: Ronald J. Hoffman, Phoenix, AZ (US); Cory W. Worth, Portland, OR (US)

Correspondence Address: PILLSBURY WINTHROP, LLP, P.O. BOX 10500, MCLEAN, VA, 22102, US

(73) Assignee: XYRON, INC., Scottsdale, AZ (US)

(21) Appl. No.: 10/761,220

(22) Filed: Jan. 22, 2004

Related U.S. Application Data
(60) Provisional application No. 60/441,350, filed on Jan. 22, 2003.

(51) Int. Cl. B26F 3/02

(52) U.S. Cl. 225/46; 242/588.6

(57) ABSTRACT

The present application discloses a dispenser system with a plurality of dispensers in a linear array. The present application also discloses a modular approach to making dispensers.

The present application claims priority to U.S. Provisional Application Serial No. 60/441,350 filed Jan. 22, 2003, the entirety of which is hereby incorporated into the present application by reference.

### FIELD OF THE INVENTION

The present invention relates to dispensers for containing crafting and graphic design supplies, such as, for example, an adhesive transfer substrate, a flexible magnetized substrate, a substrate with a series of double-sided adhesive tabs, a series of photo corners or adhesive discs.

### BACKGROUND OF THE INVENTION

In crafting and graphic design, users often engage in wide range of activities, such as scrapbooking, collage making, constructing school reports, magnet making, mocking up product packaging or advertisements, etc. In engaging in these activities, users often have a need for a wide range of supplies. For example, a crafting hobbyist may have various supplies to meet different needs, and these supplies can include items such as flexible magnet substrate for making magnet backings for a picture or other substrate, various types of adhesive transfer substrates or glue sticks for applying adhesive to the back of a picture or other substrate (including repositionable and permanent adhesives), double sided adhesive tabs to be applied in spaced apart relation to the back of a picture or other substrate, photo corners for adhering to a photo album page or other surface and receiving the corners of a picture or other substrate for mounting, adhesive discs for mounting larger substrates, etc. Graphic designers engaged in mocking up advertisements, product packaging, company reports, etc. also have a use for such supplies in their activities.

However, under the current state of the art, these supplies are all sold individually in their own devices or packages, and there is no convenient way of easily storing or managing a wide range of supplies. Usually, a user of these supplies will just leave them all in a desk drawer, as leaving them on a desk surface can look rather disorganized. Some of the more dedicated crafters and graphic designers are known to leave all their supplies in a toolbox or fishing tackle box, simply to provide some level of storage and organization to their supplies. However, these are not optimal storage arrangements, particularly when the user is actively engaged in a project, as the user must either lay all his/her necessary supplies out on the work surface, or repeatedly sift through the storage drawer or box to retrieve supplies as needed. After the project is over, to maintain a neat working area, the user then typically will take all the supplies and re-store them.

Additionally, typical dispensers of this type are made individually and have different configurations and housings. This increases the overall cost of manufacturing a product line-up including dispensers with different types of supply substrates.

### SUMMARY OF THE INVENTION

One aspect of the present invention provides a system whereby various supplies of crafting and/or graphic design can be neatly organized and managed.

Also, another aspect of the present invention provides a device having a housing wherein the housing is constructed so that it can be used by the manufacturer for containing crafting and/or graphic design supplies of varying types without the need for designing and manufacturing housings of various configurations individually adapted for individual supplies. This aspect also provides a related method making different types of dispensers.

While these aspects may be used in conjunction with one another, they may be practiced separately. That is, it is within the scope of the invention to provide a device having a housing wherein the housing is constructed so that it can be used by the manufacturer for containing crafting and/or graphic design supplies of varying types, without designing the device for inclusion into an organized system; and, conversely, it is within the scope of the invention to provide an organized system without the devices of the system having housings are constructed so that they can be used by the manufacturer for containing crafting and/or graphic design supplies of varying types.

Other objects, features, and advantages of the present invention will become apparent from the following detailed description and the accompanying drawings.

### BRIEF DESCRIPTION OF THE DRAWINGS

FIG. 1 is a perspective view of a device constructed according to the present invention;

FIG. 2 is a perspective view of the device of FIG. 1, but taken from a different angle;

FIG. 3 is a side profile view of the device of FIG. 1;

FIG. 4 is a cross-sectional view taken along line A-A in FIG. 3;

FIG. 5 is a top view of the device of FIG. 1;

FIG. 6 is a cross-section taken along line B-B of FIG. 5;

FIG. 7 is a perspective exploded view of the device of FIG. 1;

FIG. 8 is a perspective exploded view of the device of FIG. 1, but taken from a different angle;

FIG. 9 is a cross-sectional view similar to FIG. 4 showing a substrate routing for one configuration;

FIG. 10 is a cross-sectional view similar to FIG. 4 showing a substrate routing for another configuration; and

FIG. 11 is a cross-sectional view similar to FIG. 4 showing a substrate routing for another configuration.

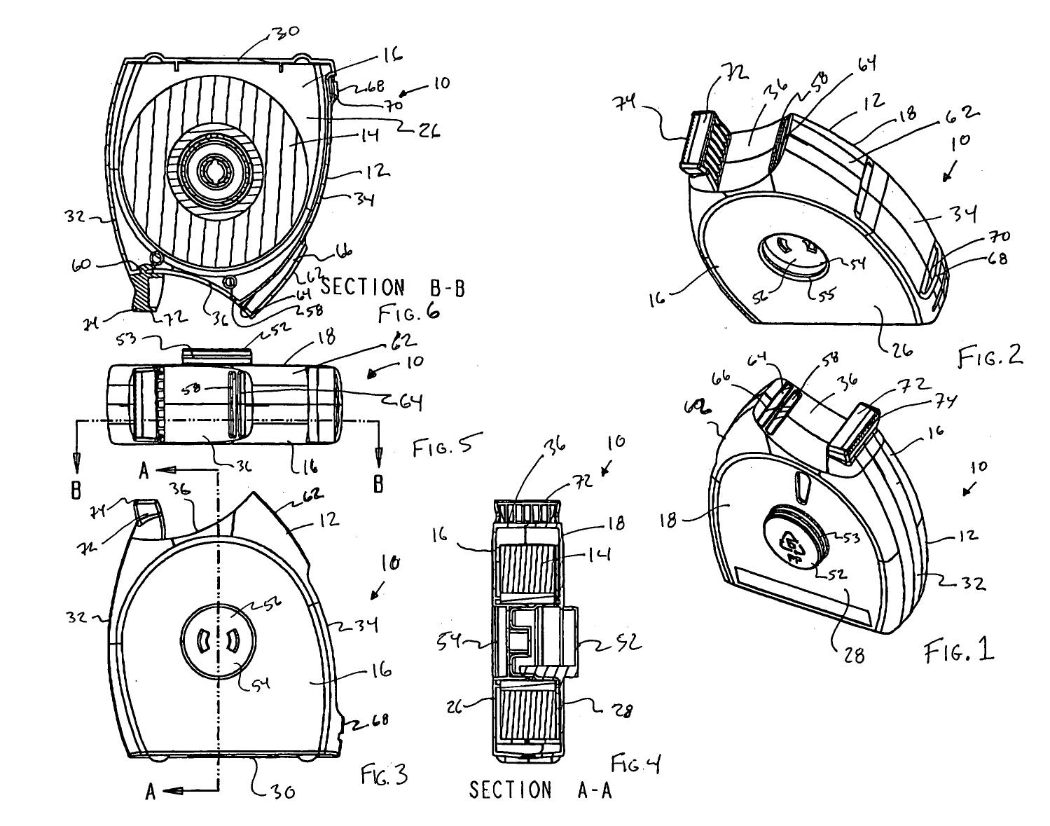

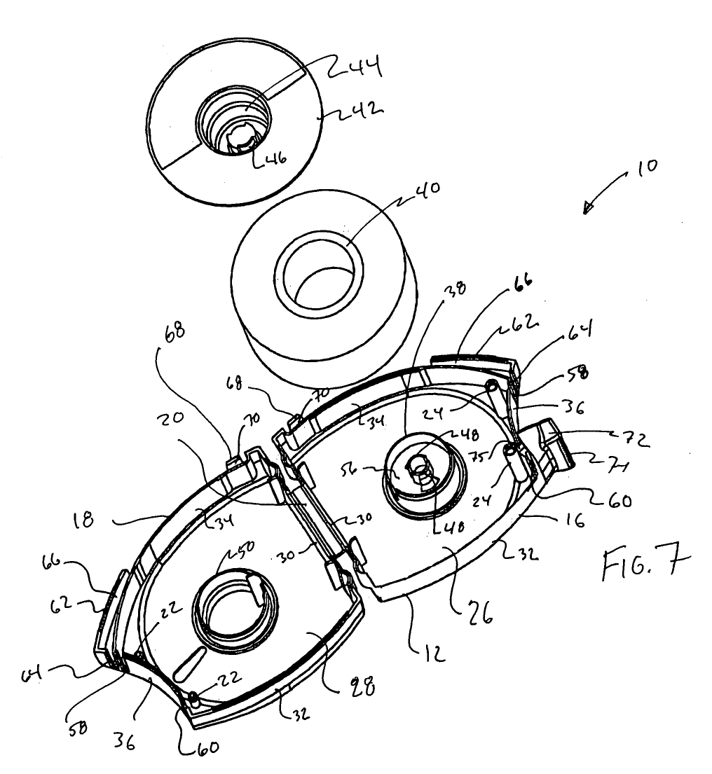

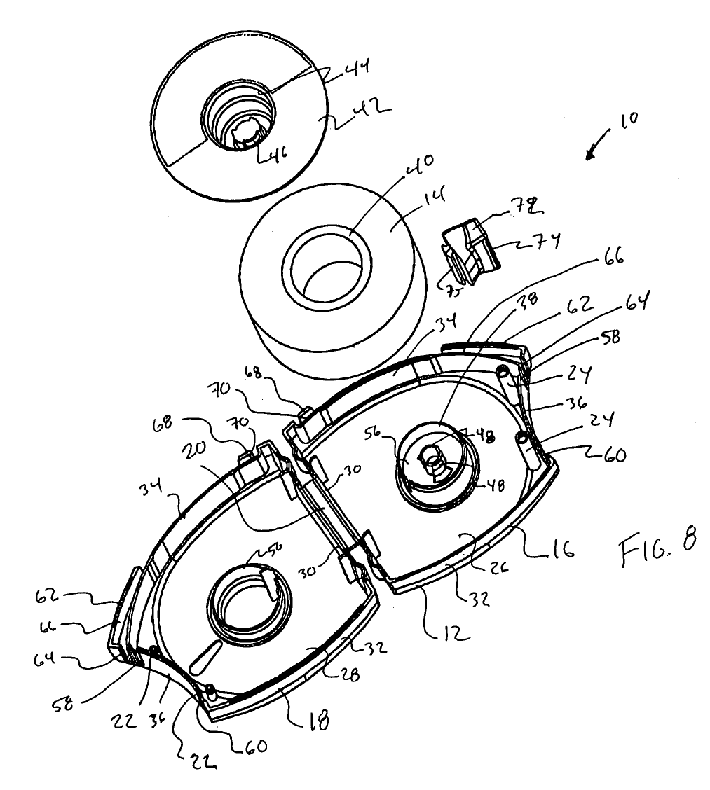

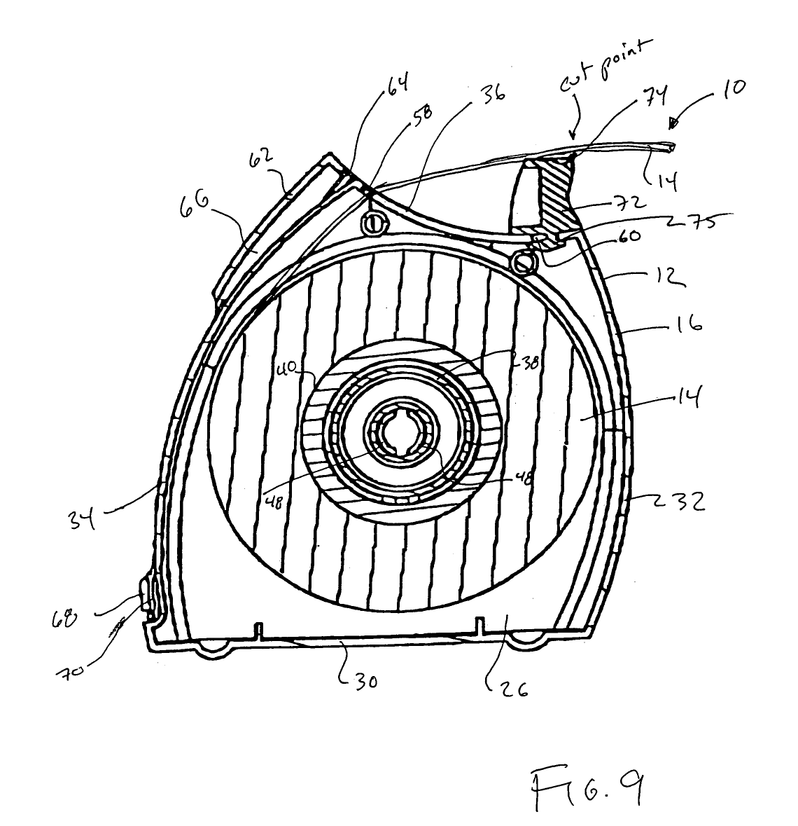

### DETAILED DESCRIPTION OF THE ILLUSTRATED EMBODIMENT

The Figures illustrate a device, generally indicated at 10. The device 10 includes a housing 12 and a supply of a substrate 14 wound in rolled format. The substrate may take a wide range of forms and may be, for example, an adhesive transfer substrate in the form of a release liner coated with a permanent or repositionable pressure-sensitive adhesive releasably adhered thereto; a photo-corner carrier substrate in the form of a release liner with a series of photo corners with pressure-sensitive adhesive on the back thereof releasably adhered to the release liner; an adhesive disc carrier substrate in the form of a release liner with a series of solidified pressure-sensitive adhesive discs releasably adhered to the release liner; standard pressure-sensitive tape including a backing with adhesive aggressively adhered thereon; an adhesive tab carrier in the form of a release liner with a series of double sided adhesive tabs (i.e., small sections of substrate with repositionable or permanent pressure-sensitive adhesive applied to both sides thereof) releasably adhered to the release liner; or a flexible magnet substrate with repositionable or pressure-sensitive adhesive aggressively adhered on one side thereof for adherence to an object as a magnet backing. The range of supplies for which the device can be used is not limited to those discussed above, and the invention is not intended to be limited to these specific examples. For example, the supplies could also be relatively thick foam or soft plastic tabs with adhesive aggressively adhered on one or both sides thereof and releasably adhered to a release liner, a relatively thick pad of adhesive putty releasably adhered to a release liner, or one-half of a hook and loop type fastener (such as that sold under the VELCRO brand) with adhesive on a backside thereof releasably adhered to a release liner (e.g., a backing with a plurality of hooks on one side thereof, and adhesive aggressively bonded on the other side thereof and releasably adhered to the release liner). All of these examplary supplies may be considered as supplies including an adhesive.

The housing 12 may have any construction or configuration and is not limited to the illustrated embodiment herein. With reference to the illustrated embodiment, the housing 12 is formed of two molded plastic halves 16, 18 coupled together by a living hinge 20. The halves 16, 18 may be formed by injection molding, for example. The halves 16, 18 close together and are secured in any suitable manner, such as by snap-fitting, gluing, heat staking, ultrasonic welding, etc. A series of posts and receptacles 22, 24 engage one another and establish the securing points. The housing 12 has two main walls 26, 28 generally parallel to one another; a bottom wall 30 extending between the two main walls 26, 28; a pair of walls 32, 34 extending upwardly from the bottom wall 30 and between the two main walls 26, 28; and a top wall 36 extending between the walls 32, 34 and between the main walls 26, 28. The bottom wall 30 has a generally flat configuration for stably supporting the device 10. The main walls 26, 28 are also generally flat. The walls 32, 34 are somewhat curved, tapering inwardly to their upper ends, and the top wall 36 is curved, with a concave configuration facing upwardly.

The inner surface of main wall 26 has a hub 38 extending inwardly therefrom, and a core 40 of the supply 14 rotatably mounts on the hub 38 while the housing 12 is opened. A generally circular disc 42 also has a hub 44 that mounts inside the core 40. The hub 44 has a structure extending inwardly and providing a pair of tab receiving spaces 46. The main wall 26 has a pair of tabs 48 extending inwardly therefrom, located within hub 38. These tabs 48 snap into the spaces 46 to secure the disc 42, and hence the supply 14, in place. The other main wall 28 has a hub 50 extending inwardly therefrom, and this extends inside the hub 44 of the disc 42 for additional support and location.

The exterior of main wall 28 has a generally cylindrical projection 52 extending outwardly therefrom opposite hub 50, and the exterior of main wall 26 has a generally cylindrical recess 54 extending inwardly therefrom and sharing a common wall 56 with hub 38. The projection 52 and the recess 54 are matching in size so that the projection 52 of one device 10 can be inserted into the recess 54 of an adjacent device 10 with the main walls 26, 28 of the two devices 10, 10 being immediately adjacent, and preferably engaged with one another. These interlocking structures enable a plurality of these devices 10 in a linear array to be arranged and secured adjacent one another so that the user has an organized system of devices 10 having a variety of different types of supplies. Specifically, this enables the user to take all his/her devices 10 having different supplies, and assemble them together into a neatly arranged system, instead of either leaving different devices strewn about a work area individually, or storing them individually in a drawer or box for later retrieval. The devices 10 in this neat arrangement can be left on the work surface for ready access whenever the user wishes to commence or recommence a project. Additionally, because the devices 10 are assembled together as desired, the user can purchase only those types of supplies he/she wants, and assemble a suitable system of supplies tailored to his/her use. As supplies are spent, the user can replenish any individual supply by removing the relevant device 10 from the array, and substitute a full device 10 for it. Alternatively, the user could remove the device 10 from the array, open it, reload a fresh supply in place of the spent one, and then place the device 10 back in the array.

The projection 52 is furnished with a slight annular ridge 53 about its exterior and the recess 54 is furnished with a slight detent 55 about its interior. The ridge 53 of one device 10 will engage the detent 55 of another device 10 when the devices 10, 10 are coupled together by projection 52 and recess 54 to form a snap fit that releasably secures the devices 10, 10 together. It should be understood, however, that any suitable construction could be used for coupling devices 10, 10 together, and the invention is not limited to the example shown. For example, magnets in the main walls 26, 28 could be used to magnetically secure ′devices 10, 10 together with or without a projection and recess for facilitating alignment, other types of snap fit arrangements (such as multiple snap fitting projections and recesses) could be used, or a press-fit relationship between projection 52 and recess 54 or multiple projections and recesses could be used. Any other suitable construction or configuration could also be used. For example, a rack that holds multiple devices in a linear array may be used.

To enable the device 10 to be used with supplies of varying types, the top wall 36 is provided with different openings. These openings include a first opening 58 and a second opening 60 each opening to the interior of the device 10. These openings 58 and 60 are of different thicknesses. In the illustrated embodiment, the first opening 58 has a thickness in the range of 0.25 mm to 5 mm, with a preferred thickness of 1 mm; and the second opening 60 has a thickness in the range of 0.25 mm to 10 mm, with a preferred thickness of 23 mm. These dimensions are only examples and not limiting. Preferably, the second opening 60 is substantially thicker than the first opening 58. By substantial, it is meant that the difference is more than nominal such that thicker substrates can pass through the second opening 60. Additionally, a guide wall 62 is formed on wall 34 and extends downwardly from or near the corner at the top wall 36 only part way. This guide wall 62 forms third opening 64 adjacent the first opening 58 and a guide passage 66 extending between the guide wall 62 and wall 34, which terminates about one-third of the way down wall 34. A secondary guide wall 68 is also provided at the lower end of wall 34 and forms a secondary guide passage 70 between it and wall 34 with two open ends. The third opening 64 and the passages 66, 70 have thickness approximately the same as first opening 58. The role these structures play in providing the device 10 with versatility for use with different supplies will be discussed below in the context of different supplies.

In one configuration, the supply may be of the type that the user typically uses by pulling out a desired length, and then cutting that length off. An example of this is where the supply is an adhesive transfer substrate, a magnet substrate, or standard adhesive tape wherein the user wants to use a predetermined length of supply (e.g., 2 inches). FIG. 9 illustrates a routing for such an usage. The substrate 14 extends from the roll and out of the first opening 58. A cutter 72 with a serrated upper edge 74 is mounted in the second opening 60, and the user uses the cutter 72 by pulling the substrate 14 over the edge 74 to sever a desired length of the substrate 14.

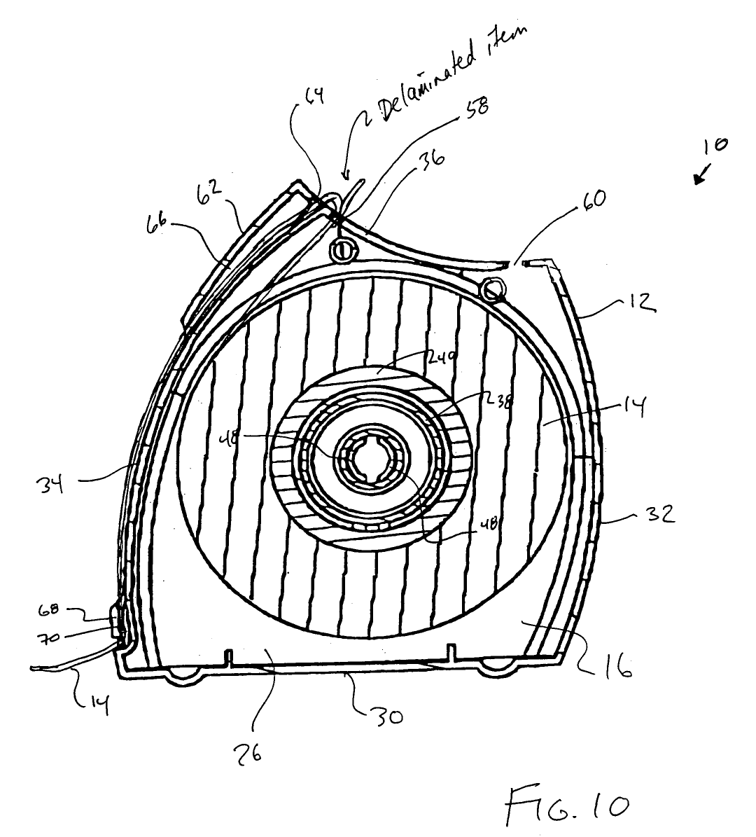

The cutter 72 is mounted via a T-shaped mounting element 75 extending downwardly therefrom, and which is mounted into the second opening 60 while the housing 12 is open so that it is secured in place upon closing the halves 16, 18 (see FIGS. 7 and 8). However, any suitable construction or configuration may be used for cutting, and the invention is not limited to the construction or configuration disclosed.

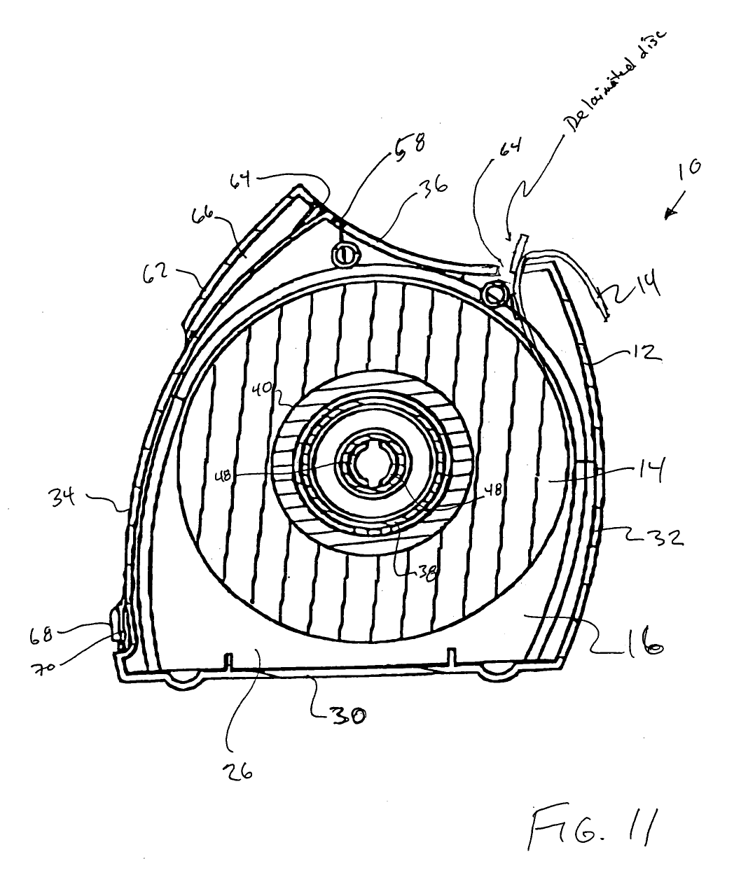

In another configuration, the supply may be of the type that the user needs to sharply bend the substrate 14 to delaminate an item adhered thereon from the substrate 14. Double-sided adhesive tabs and photo corners would be examples of this type of supply, as they are easier to remove by hand when the substrate 14 is bent quite sharply, i.e., usually more than 90 degrees, and preferably more than 120 degrees, and still more preferably more than 150 degrees. FIG. 10 illustrates a routing for such a usage. The substrate 14 extends from the roll and out of the first opening 58, and then is bent back over the corner between wall 34 and top wall 36. Alternatively, the first opening 58 may be provided adjacent the corner defined by any two intersecting walls, with the first opening 58 being on either wall adjacent the corner. This sharply bends the substrate 14 over the corner so as to delaminate the item adhered thereon for the user to easily grasp with his/her fingers. Additionally, by feeding the substrate 14 through passage 66 and then into passage 70, the user can frictionally contact the section of substrate 14 exposed between the two passages 66, 70 with a finger or thumb to easily advance the substrate 14 in increments to advance and delaminate subsequent items. The waste portions will be directed out the bottom of the secondary passage 70 where they can be cut off or tom off. In this configuration, the secondary guide wall 68 and its passage 70 is not necessary and is only a preferred feature. Also, in this configuration the cutter 72 is not needed and may be omitted to save costs in parts and assembly.

In yet another configuration, the supply may be of the type wherein the substrate 14 is relatively thick, such as a very thick magnetized substrate, or includes a liner carrying relatively thick items adhered thereon for delamination, such as adhesive discs. FIG. 11 illustrates a routing for this configuration. The substrate 14 extends from the roll and out the second opening 58, and the cutter 72 is removed. If relative thick items are being delaminated, the user can bend the substrate over the adjacent corner to affect the delamination. With thick items, the degree of bending does not need to be a sharp as with thin items, like double-sided tabs and photo-corners, as the relatively higher stiffness of a thicker article will enable it to delaminate more readily. Also, by making the second opening 60 thicker, it is easier to feed the substrate therethrough.

Thus, it can be appreciated that using the same housing 12, a wide variety of different devices 10 can be constructed simply by routing the substrate 14 differently and adding or removing the presence of the cutter 72. This enables the manufacturer to significantly save costs, as only one housing 12 needs to be produced, and can be used in a modular assembly fashion to produce the different types of devices by changing the supplies and their respective routings. To provide some degree of differentiation between the devices, they may be labelled or the housings could be molded with a different color plastic for each type of device. However, the present invention is not limited to the construction illustrated, and the housing 12 may have other configurations. For example, the cutter 72 is not a necessary feature, although it is preferred to eliminate the need for scissors or manual tearing. Also, second opening 60 could eliminated and first opening 58 could be widened for accommodating thicker supplies. Further, the location, spacing and/or orientation of any openings could be changed as desired.

In this modular approach, a plurality of housings having essentially identical construction would be provided. By essentially identical, it is meant that the housings are the same from a structural standpoint, but they may come in different colors, with different labels, or have different markings (such as logos or words) formed therein. As described, each housing would have a first opening 58 provided on a wall adjacent a corner, and a second opening, with the second opening 60 being thicker than the first opening. A number of wound rolls of a first type of supply substrate would be provided, and this could be of the type including a release liner with relatively thin articles and an adhesive releasably adhering the thin articles to the liner (e.g., a photo corner substrate, or an adhesive tab substrate). A number of wound supply rolls of a second type would also be provided. The second type would be somewhat thicker, either by carrying relatively thick items like adhesive discs for delamination, or by being a thick substrate like a heavy duty magnet. To pass through the second opening 60, the thickness of the second type of substrate would be less than that of the second opening 60.

The wound rolls of the first type of supply substrate would be mounted to a first corresponding number of housings (e.g., 1000 of these rolls would be mounted in 1000 of the housings), and the lead end portion of the substrate would be extended through the first openings 58 of these housings. To delaminate an article, the substrate can be bent over a corner as discussed above. The wound rolls of the second type of substrate would be mounted to a second corresponding number of housings (e.g., 1000 of these rolls would be mounted to another 1000 housings), and the unwound lead end portion would be extended through the second openings 60 of these housings.

The first and second types of supply substrates could be selected from any of the types mentioned above, or any other types.

This modular approach could be expanded to make more than two different types of dispensers. For example, three, four, five or more could be made using the same basic housing.

The cutter 72 could be mounted in the second opening during this approach, and would be particularly useful for the types of uses described above with respect to FIG. 9.

To facilitate clearing any jamming of the supply substrate without having to remove a device 10 from its interlocked array, the top wall could be pivotally movable so that it can be opened to access the housing interior.

The foregoing embodiment has been provided solely for illustrating the structural and functional principles of the present invention and should not be considered limiting. To the contrary, the present invention is intended to encompass any and all modifications, substitutions, and equivalents.

What is claimed:

1. A dispenser system comprising:
at least two dispensers, each dispenser comprising a housing and a wound roll of a supply substrate carried in the housing wherein the supply substrate can be unwound and dispensed from the roll for use;
the at least two dispensers being secured together in a linear array;
wherein the supply substrates of the at least two dispensers are different types and each include an adhesive.

2. A dispenser system according to claim 1, wherein the supply substrates of the at least two dispensers are selected from the group consisting of (i) a wound adhesive transfer substrate including a release liner having adhesive releasably adhered thereto, (ii) a wound adhesive tab substrate including a release liner and a plurality of substrate tabs with adhesive aggressively adhered on each side thereof, the tabs being releasably adhered on the release liner, (iii) a magnet making substrate including a flexible magnetized substrate with adhesive aggressively adhered thereon, (iv) a solidified adhesive member substrate including a release liner and a plurality of solidified, relatively thick members formed of solidified adhesive and releasably adhered to the liner, (v) adhesive tape including a backing with adhesive aggressively adhered thereon, and (vi) a photo corner substrate including a release liner and a plurality of photo corners with adhesive aggressively adhered on the photo corners and releasably adhered to the release liner.

3. A dispenser system according to claim 1, wherein the housings of the at least two dispensers are secured directly together.

4. A dispenser system according to claim 3, wherein the housings of the at least two dispensers are secured directly together by interlocking structures.

5. A dispenser system according to claim 4, wherein the interlocking structures are provided on lateral side walls of the housings that faces axially with respect to the wound rolls of the supply substrate.

6. A dispenser system according to claim 5, wherein the interlocking structures include a recess provided on one lateral side wall of each housing and a projection provided on the other lateral side wall of each housing, the projections being sized to fit tightly into the recesses to secure the dispensers together.

7. A method of assembling a dispenser system, the method comprising:
providing at least two dispensers, each dispenser comprising a housing and a wound roll of a supply substrate carried in the housing, wherein the supply substrate can be unwound and dispensed from the roll for use, the supply substrates of the at least two dispensers being different types and each including an adhesive; and
securing the at least two dispensers together in a linear array.

8. A method according to claim 7, wherein the supply substrates of the at least two dispensers are selected from the group consisting of (i) a wound adhesive transfer substrate including a release liner having adhesive releasably adhered thereto, (ii) a wound adhesive tab substrate including a release liner and a plurality of substrate tabs with adhesive aggressively adhered on each side thereof, the tabs being releasably adhered on the release liner, (iii) a magnet making substrate including a flexible magnetized substrate with adhesive aggressively adhered thereon, (iv) a solidified adhesive member substrate including a release liner and a plurality of solidified, relatively thick members formed of solidified adhesive and releasably adhered to the liner, (v) adhesive tape including a backing with adhesive aggressively adhered thereon, and (vi) a photo corner substrate including a release liner and a plurality of photo corners with adhesive aggressively adhered on the photo corners and releasably adhered to the release liner.

9. A method according to claim 7, wherein the housings of the at least two dispensers are secured directly together.

10. A method according to claim 9, wherein the housings of the at least two dispensers are secured together by interlocking structures.

11. A method according to claim 10, wherein the interlocking structures are provided on lateral side walls of the housings that face axially with respect to the wound rolls of the supply substrate, wherein the housings are secured directly together by bringing the lateral side walls of housings together to engage the interlocking structures.

12. A method according to claim 11, wherein the interlocking structures include a recess provided on one lateral side wall of each housing and a projection on the other lateral side wall of each housing, the projections being sized to fit tightly into the recesses to secure the dispensers together,
wherein the housings are secured directly together fitting the projection and the recess of adjacent housings together.

13. A method for making a plurality of different types of dispensers, the method comprising:
providing a plurality of housings having essentially identical constructions, each housing comprising:
(i) at least a first opening and a second opening spaced apart from the first opening, each opening having a thickness, the thickness of the first opening being smaller than the thickness of the second opening, and
(ii) a corner defined by two intersecting walls, the first opening being provided on one of the walls adjacent the corner,
providing a number of wound rolls of a first type of supply substrate, the first type of supply substrate including a release liner with relatively thin articles and an adhesive releasably adhering the relatively thin articles to the release liner;
providing a number of wound rolls of a second type of supply substrate, the second type of supply substrate being relatively thicker than the first supply substrate, but being thinner than the thickness of the second opening;
mounting the wound rolls of the first type of supply substrate to a first corresponding number of the housings and extending an unwound lead end portion of the first type of supply substrate through the first openings of the first corresponding number of housings;
mounting the wound rolls of the second type of supply substrate to a second corresponding number of the housings and extending an unwound lead end portion of the second type of supply substrate through the second openings of the second corresponding number of housings.

14. A method according to claim 13, wherein the first type of supply substrates is selected from the group consisting of (i) a wound adhesive tab substrate including a release liner and a plurality of substrate tabs with adhesive aggressively adhered on each side thereof, the tabs being releasably adhered on the release liner, and (ii) a photo corner substrate including a release liner and a plurality of photo corners with adhesive aggressively adhered on the photo corners and releasably adhered to the release liner.

15. A method according to claim 13, wherein the second type of supply substrate is selected from the group consisting of (i) a magnet making substrate including a flexible magnetized substrate with adhesive aggressively adhered thereon, and (ii) a solidified adhesive member substrate including a release liner and a plurality of solidified, relatively thick members formed of solidified adhesive and releasably adhered to the liner.

16. A method according to claim 14, wherein the second type of supply substrate is selected from the group consisting of (i) a magnet making substrate including a flexible magnetized substrate with adhesive aggressively adhered thereon, and (ii) a solidified adhesive member substrate including a release liner and a plurality of solidified, relatively thick members formed of solidified adhesive and releasably adhered to the liner.

17. A method according to claim 13, further comprising mounting a cutter to in the second opening of the first corresponding number of housings, the cutter providing a cutting edge for cutting the first type of adhesive substrate.

18. A method according to claim 17, wherein the first type of supply substrate is an adhesive tape including a backing with adhesive aggressively adhered thereon.

19. A housing for use in a dispenser for different types of dispensers, the housing comprising:
at least a first opening and a second opening spaced apart from the first opening, each opening having a thickness, the thickness of the first opening being smaller than the thickness of the second opening, and
a corner defined by two intersecting walls, the first opening being provided on one of the walls adjacent the corner,
the housing enabling (a) a wound roll of a first type of supply substrate, including a release liner and relatively thin articles and an adhesive releasably adhering the relatively thin articles to the release liner, to mounted in the housing with an unwound lead end portion of the first type of supply substrate extending through the first opening, or (b) a wound roll of a second type of supply substrate that is relatively thicker than the first supply substrate, but thinner than the thickness of the second opening, to be mounted in the housing with an unwound lead end portion of the second type of supply substrate extending through the second opening.
